(19) United States
(12) Patent Application Publication
(10) Pub. No.: US 2009/0148643 A1
(43) Pub. Date: Jun. 11, 2009

(54) Supply wax for polisher

(76) Inventor: Tsung Chen Yu, Taichung (TW)

Correspondence Address: SAM CHEN, 7F-1, 293, ROOSEVELT ROAD, SEC 3, TAIPEI, TW

(21) Appl. No.: 11/951,313

(22) Filed: Dec. 5, 2007

(51) Int. Cl. B32B 33/00

(52) U.S. Cl. 428/40.5

(57) ABSTRACT

A supply wax structure of a reel for a polisher includes a protective layer on one surface; a releasable layer on the other surface; and a wax layer adhered between the protective layer and the releasable layer. In one embodiment, the protective layer has a plurality of first apertures arranged in rows filled with wax and the releasable layer has a plurality of second apertures arranged in rows filled with wax. Preferably, the releasable layer is formed of fabric. Preferably, the protective layer is formed of paper. Preferably, the width of the wax layer is substantially equal to that of a polishing wheel of the polisher.

### BACKGROUND OF THE INVENTION

1. Field of Invention

The invention relates to supply wax for polisher and more particularly to a supply wax reel for polisher in which the wax has an improved structure such that an optimum amount of wax can be continuously supplied to an operating polisher.

2. Description of Related Art

Conventionally, wax is manually supplied to an operating polisher for polishing a piece being worked thereon. This is not safe and is labor intensive.

Taiwanese Utility Model Patent No. 407,555 discloses an automatic supply wax reel for polisher. However, its operation, polishing effect, and wax consumption are not advantageous. Thus, a need for improvement exists.

### SUMMARY OF THE INVENTION

It is therefore one object of the invention to provide a supply wax reel for polisher in which the wax structure comprises a thin protective layer on one surface, a thin releasable layer on the other surface, and a wax layer formed therebetween such that an optimum amount of wax can be continuously supplied to an operating polisher for polishing a workpiece being worked thereon.

The above and other objects, features and advantages of the invention will become apparent from the following detailed description taken with the accompanying drawings.

### BRIEF DESCRIPTION OF THE DRAWINGS

FIG. 1 is a perspective view of a supply wax reel in which the wax structure is constructed in accordance with a first preferred embodiment of the invention;

FIG. 2 is a longitudinal sectional view of the wax structure of FIG. 1;

FIG. 3 is a side elevation of the wax structure of FIG. 1;

FIG. 4 is a side elevation schematically depicting a workpiece polishing operation involving the supply wax reel, a take-up reel, and a polishing wheel of a polisher;

FIG. 5 is an enlarged view of the guiding device and its adjacent components shown in FIG. 4;

FIG. 6 is a top plan view schematically depicting an optimum width of the wax structure;

FIG. 7 is a longitudinal sectional view of a wax structure constructed in accordance with a second preferred embodiment of the invention; and

FIG. 8 is an enlarged view of a guiding device and its adjacent components for the wax structure of FIG. 7.

### DETAILED DESCRIPTION OF THE INVENTION

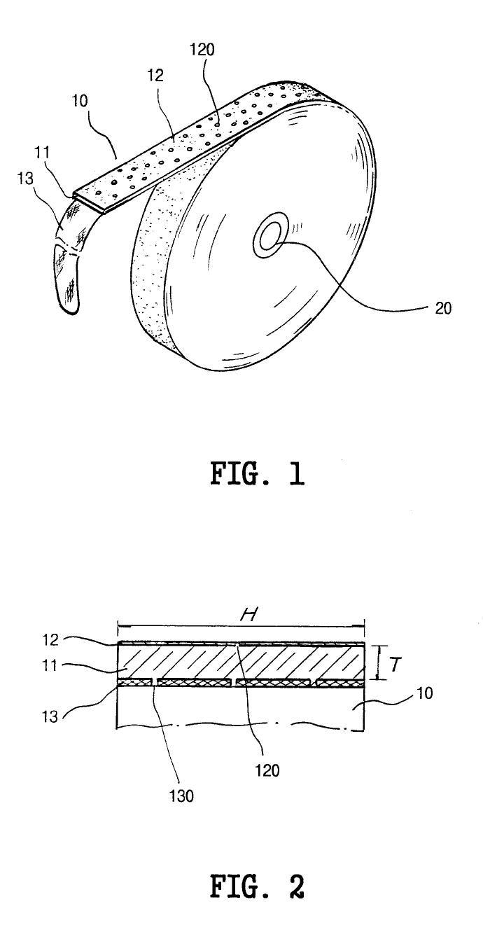

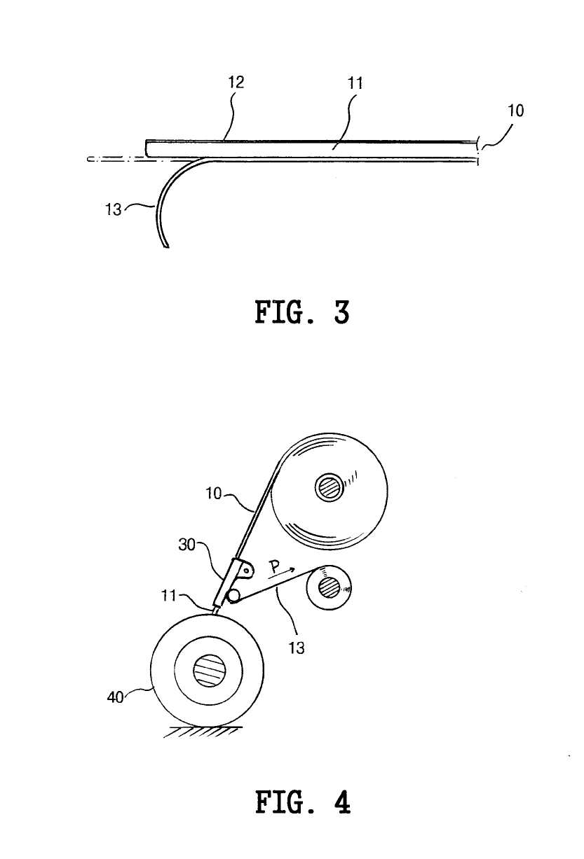

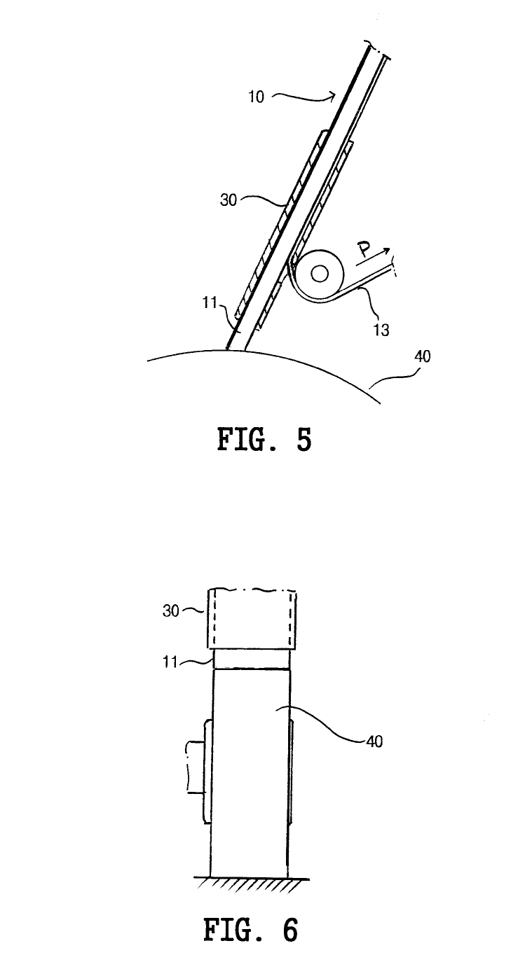

Referring to FIGS. 1 to 6, a first preferred embodiment of the invention is shown. Details of the first preferred embodiment will be discussed below.

A continuous wax structure 10 in the form of a belt is wound on a supply reel 20. The wax structure 10 comprises a thin protective layer 12 on one surface, a thin releasable layer 13 on the other surface, and a wax layer 11 formed between the protective layer 12 and the releasable layer 13.

The protective layer 12 comprises a plurality of first apertures 120 arranged in rows. The wax in the wax layer 11 fills the first apertures 120 in the manufacturing process so that adhesion of the protective layer 12 and the wax layer 11 can be secured. Preferably, the protective layer 12 is made of paper and will be consumed in the polishing operation.

The releasable layer 13 is made of fabric of low resilience but is relatively strong in texture. Also, the releasable layer 13 comprises a plurality of second apertures 130 arranged in rows. The wax in the wax layer 11 fills the second apertures 130 in the manufacturing process so that adhesion of the releasable layer 13 and the wax layer 11 can be secured but still permits the releasable layer 13 to easily release from the wax layer 11 in the workpiece polishing operation as detailed later.

The thickness T of the wax layer 11 is adapted to vary depending on factors including a polishing wheel 40 of a polisher (not shown), the desired polishing degree of a workpiece (not shown), etc. Also, the width H of the wax layer 11 is adapted to vary depending on factors including the width of the polishing wheel 40, etc. Preferably, the width H of the wax layer 11 is substantially the same as that of the polishing wheel 40 so that the workpiece placed on the polishing wheel 40 can be sufficiently polished by the supplying wax in the workpiece polishing operation as detailed later.

A polishing operation of the invention will be described in detail below. Peel a portion of the releasable layer 13 out of an open end of the wax structure 10. Next, pass the open end of the wax structure 10 through a hollow cylinder (not numbered) of a guiding device 30 with the open end of the wax structure 10 to be in contact with the polishing wheel 40 and the peeled portion of the releasable layer 13 passing a surface opening (not numbered) of the cylinder of the guiding device 30. The peeled portion of the releasable layer 13 then engages an arc of a roll (not numbered) of the guiding device 30 prior to winding on a take-up reel (not numbered). Next, activate the polisher to rotate the polishing wheel 40 with the take-up reel rotating in a speed of a predetermined times of that of the polishing wheel 40. The releasable layer 13 will wind on the take-up reel in the operation as indicated by arrow P. Also, a workpiece (not shown) is placed in the joining portion of the wax layer 11, the protective layer 12, and the polishing wheel 40 so that the workpiece can be polished during the operation.

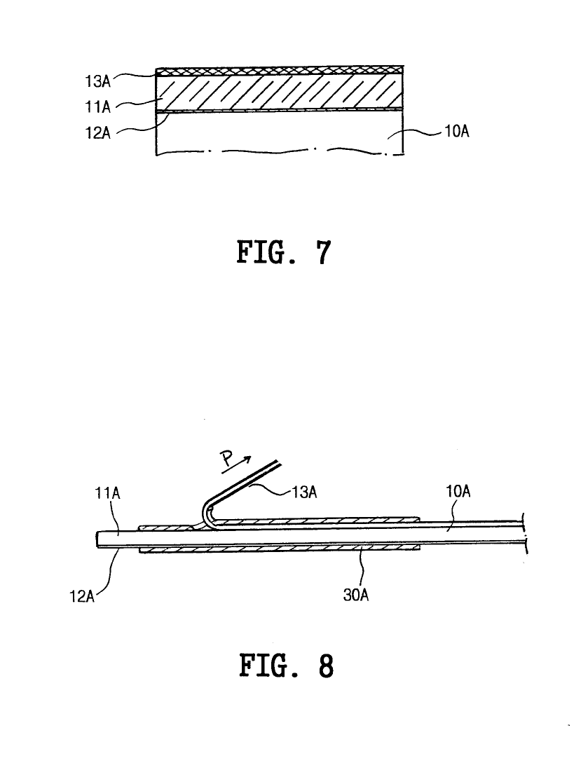

Referring to FIGS. 7 and 8, a second preferred embodiment of the invention is shown. The second embodiment is identical to the first embodiment, except that there are no apertures in both the protective layer 12A and the releasable layer 13A and the wax of the wax layer 11A has a more strong adhesion as compared with that of the first preferred embodiment so that the wax layer 11A, the protective layer 12A, and the releasable layer 13A can be securely adhered together prior to peeling the releasable layer 13A out of the remaining part of the wax structure 10A.

While the invention herein disclosed has been described by means of specific embodiments, numerous modifications and variations could be made thereto by those skilled in the art without departing from the scope and spirit of the invention set forth in the claims.

What is claimed is:

1. A wax structure of a reel for a polisher comprising:
a protective layer on one surface;
a releasable layer on the other surface; and
a wax layer adhered between the protective layer and the releasable layer.

2. The wax structure of claim 1, wherein the protective layer comprises a plurality of first apertures arranged in rows filled with wax.

3. The wax structure of claim 1, wherein the releasable layer comprises a plurality of second apertures arranged in rows filled with wax.

4. The wax structure of claim 1, wherein the releasable layer is formed of fabric.

5. The wax structure of claim 1, wherein the protective layer is formed of paper.

6. The wax structure of a reel for a polisher of claim 1, wherein the width of the wax layer is substantially equal to that of a polishing wheel of the polisher.
